(19) United States
(12) Patent Application Publication
(10) Pub. No.: US 2024/0081385 A1
(43) Pub. Date: Mar. 14, 2024

(54) SEASONING PROVISION DEVICE, SEASONING PROVISION METHOD AND SEASONING PROVISION MANAGEMENT DEVICE

(71) Applicant: CJ CHEILJEDANG CORPORATION, Seoul (KR)

(72) Inventors: Dong Ju KWAK, Seoul (KR); Tae Hyun JUNG, Seoul (KR); Hee Jeong LIM, Seoul (KR); Kyung Taek PARK, Seoul (KR)

(73) Assignee: CJ CHEILJEDANG CORPORATION, Seoul (KR)

(21) Appl. No.: 18/270,336

(22) PCT Filed: Dec. 30, 2021
(86) PCT No.: PCT/KR2021/020310

§ 371 Date: Jun. 29, 2023

(30) Foreign Application Priority Data
Dec. 31, 2020 (KR) 10-2020-0189804

(51) Int. Cl. A23P 20/15; A23L 19/00; B65G 37/00; G01G 17/00

(52) U.S. Cl. CPC A23P 20/15; A23L 19/05; B65G 37/00; G01G 17/00; B65G 2201/04; B65G 2207/14

(57) ABSTRACT

A seasoning provision device according to the present invention comprises: a work unit provided to acquire the weight of a food material to be loaded thereon; a seasoning provision unit provided to form a semi-finished product by providing seasoning of a seasoning serving amount, which is a predetermined weight, to the food material loaded on the work unit; and a processor electrically connected to the work unit and the seasoning provision unit, wherein the processor controls the seasoning provision unit so that seasoning is provided according to the seasoning serving amount determined on the basis of the weight of the food material acquired by the work unit.

### TECHNICAL FIELD

The present invention relates to a seasoning provision device, a seasoning provision method, and a seasoning provision management device.

### BACKGROUND ART

In order to produce food, it is necessary to process a given food material, and such processing may include washing or trimming the food material, as well as adding seasoning or the like composed of other food materials. The seasoning may be applied to the food material, and the application may include not only making the surface of the food material come into contact with the seasoning, but also mixing the seasoning inside the food material. Generally, it is possible to prepare salting food via such a method. The salting food is food with improved shelf life by adding salt, and includes kimchi, pickled radish, salted radish, and pickled cucumber, among which kimchi is representative.

When preparing whole cabbage kimchi, it is possible to use a method of cutting a whole cabbage wrapped in several layers of leaves, pickling the same in salt water, applying seasoning, and then aging the same. The seasoning used in preparing whole cabbage kimchi may be kimchi filling including radish, red pepper powder, minced garlic, salted shrimp, or the like. In a state in which the kimchi filling is contained in a large-capacity storage tank, the seasoning may be applied by a worker holding pickled cabbages one by one near the storage tank and scooping out and applying an appropriate amount of the kimchi filling.

However, when using such a method, the worker picks up the kimchi filling by his or her eye and applies the same to a pickled cabbage with his/her hand, and thus there were problems in which there was a large variance among workers regarding an appropriate amount of seasoning, and even the same worker was not guaranteed to apply a uniform amount of seasoning. In addition, since the size of the pickled cabbage is not maintained uniformly and the appropriate amount of seasoning is also not the same for all cabbages but varies with size, there was a problem in which it became more difficult for a worker to find an appropriate amount of seasoning.

### DISCLOSURE OF THE INVENTION

### Technical Problem

The present invention, which has been devised to solve the above problems, provides a seasoning provision device, a seasoning provision method, and a seasoning provision management device for producing food of uniform quality.

### Technical Solution

A seasoning provision device according to an embodiment of the present invention includes: a work unit provided to acquire the weight of a food material to be seated thereon; a seasoning provision unit provided to form a semi-finished product by providing seasoning of a seasoning provision amount, which is a predetermined weight, to the food material seated on the work unit; and a processor electrically connected to the work unit and the seasoning provision unit, wherein the processor controls the seasoning provision unit such that seasoning is provided according to the seasoning provision amount determined on the basis of the weight of the food material acquired by the work unit.

A seasoning provision method according to an embodiment of the present invention includes: preparing a food material; acquiring the weight of the food material; and producing a semi-finished product by providing seasoning to the food material according to a seasoning provision amount determined on the basis of the acquired weight of the food material.

A seasoning provision management device according to an embodiment of the present invention includes: a receiving unit provided to receive production information including at least one of season information, the origin of the food material, the size of the food material, and the weight of the food material from a seasoning provision device; an information processing unit generating processing information on the basis of the received production information; and a transmitting unit for transmitting a control signal related to an operation mode of the seasoning provision device determined on the basis of the processing information to the seasoning provision device.

### Advantageous Effects

Accordingly, depending on a food material, an appropriate amount of seasoning is calculated, and the corresponding amount of seasoning is provided, such that food of uniform quality can be produced.

### BRIEF DESCRIPTION OF THE DRAWINGS

FIG. 1 is a side view of a seasoning provision device according to an embodiment of the present invention.

FIG. 2 is a plan view of the seasoning provision device according to an embodiment of the present invention.

FIG. 3 is a perspective view illustrating a seasoning provision unit of the seasoning provision device according to an embodiment of the present invention.

FIGS. 4 and 5 are enlarged perspective views illustrating a portion of the seasoning provision unit according to an embodiment of the present invention.

FIG. 6 is a side view of the seasoning provision unit and a work unit according to an embodiment of the present invention.

FIG. 7 is a view showing front surfaces of the seasoning provision unit and the work unit according to an embodiment of the present invention.

FIG. 8 is a perspective view of a weight acquisition transfer part according to an embodiment of the present invention.

FIG. 9 is a flow chart of a seasoning provision method according to an embodiment of the present invention.

FIG. 10 is a flowchart of a seasoning provision method according to a modified example of an embodiment of the present invention.

### MODE FOR CARRYING OUT THE INVENTION

Hereinafter, some embodiments of the present invention will be described in detail through exemplary drawings. In adding reference numerals to components of each drawing, it should be noted that the same components have the same numerals as much as possible even if they are displayed on different drawings. In addition, in describing an embodiment of the present invention, if it is determined that a detailed description of a related known configuration or function hinders understanding of the embodiment of the present invention, the detailed description will be omitted.

In addition, in describing components of an embodiment of the present invention, terms such as first, second, A, B, (a), and (b) may be used. These terms are only used to distinguish a component from other components, and the nature, sequence, or order of the corresponding component is not limited by the term. When a component is described as being “connected”, “coupled” or “linked” to another component, the component may be directly connected or liked to the other component, but it should be understood that still another component may be “connected”, “coupled” or “linked” between the components.

This application claims priority based on Korean Patent Application No. 10-2020-0189804 filed on Dec. 31, 2020, and all contents disclosed in the specification and drawings of the application are incorporated herein.

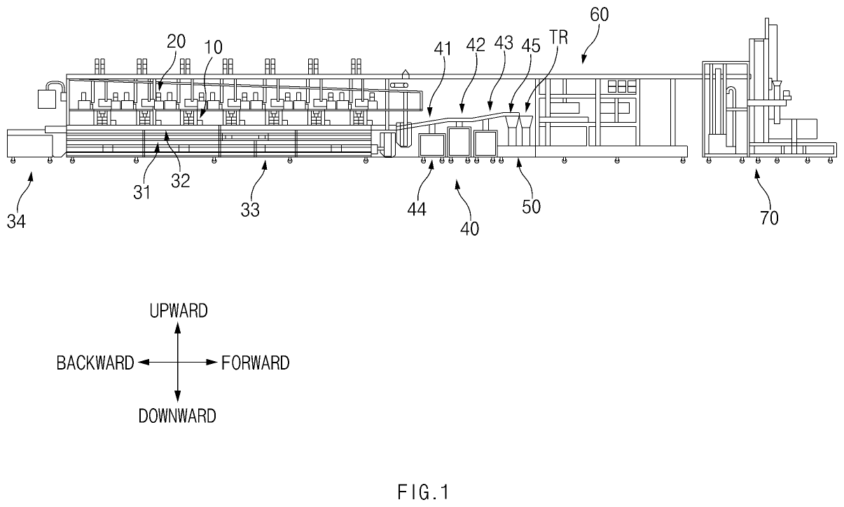

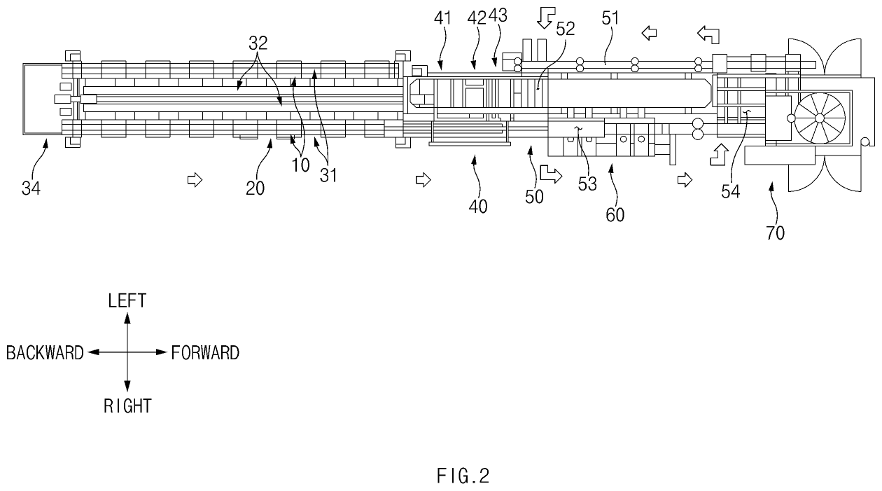

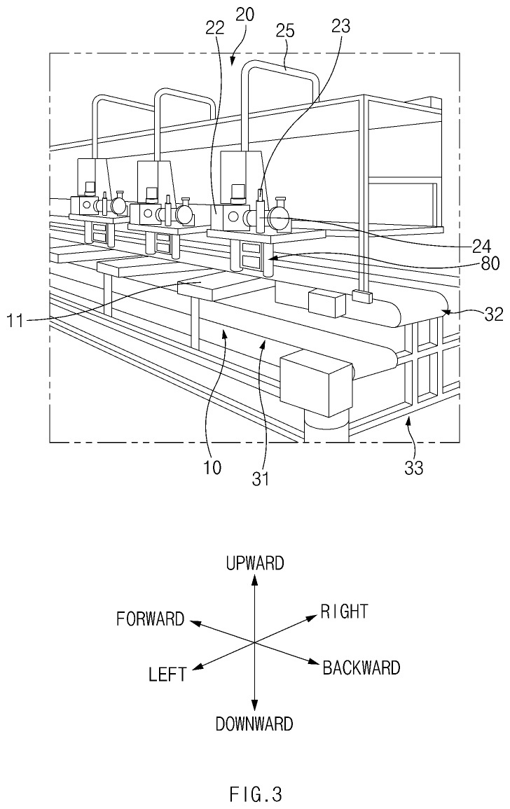

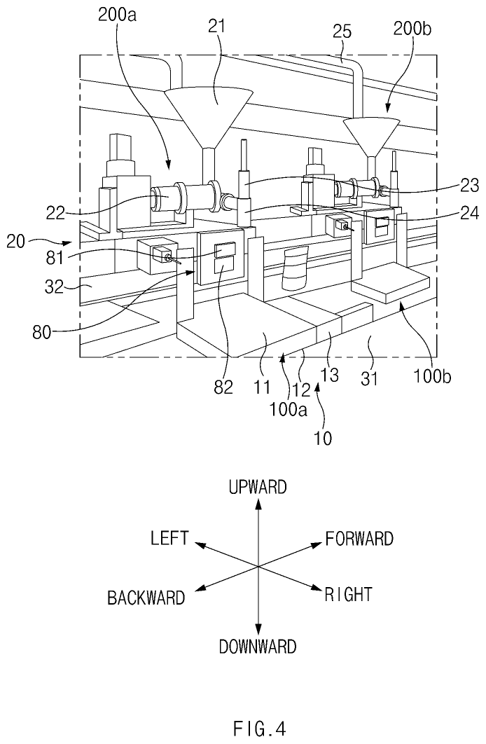

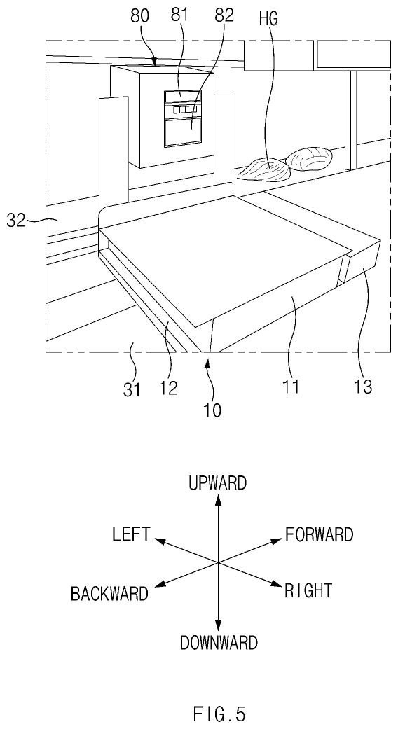

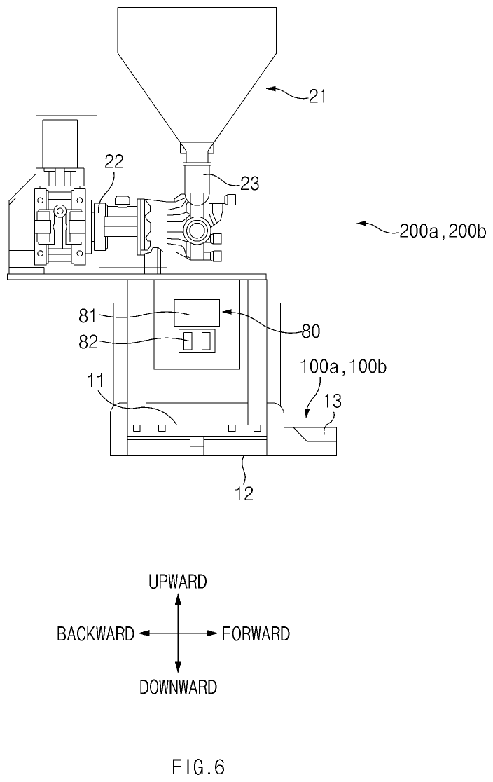

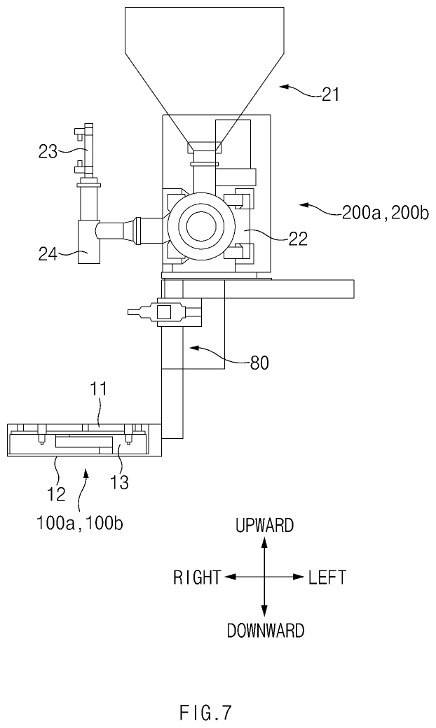

FIG. 1 is a side view of a seasoning provision device according to an embodiment of the present invention. FIG. 2 is a plan view of the seasoning provision device according to an embodiment of the present invention. FIG. 3 is a perspective view illustrating seasoning provision units 200a and 200b of the seasoning provision device according to an embodiment of the present invention. FIGS. 4 and 5 are enlarged perspective views illustrating portions of the seasoning provision units 200a and 200b according to an embodiment of the present invention. FIG. 6 is a side view of the seasoning provision units 200a and 200b and work units 100a and 100b according to an embodiment of the present invention. FIG. 7 is a view showing front surfaces of the seasoning provision units 200a and 200b and the work units 100a and 100b according to an embodiment of the present invention.

Referring to the drawings, a seasoning provision device according to an embodiment of the present invention includes a work unit 10, a seasoning provision unit 20, and a processor. A semi-finished product HG may be produced by providing seasoning to a food material seated on the work unit 10 through the seasoning provision unit 20. In the seasoning provision device according to an embodiment of the present invention, the food material may be a pickled cabbage, the provided seasoning may be kimchi, and the semi-finished product HG produced by the food material may be a kimchi semi-finished product. Since the semi-finished product HG is a product at a stage before being completed into food, food produced by the kimchi semi-finished product may be whole cabbage kimchi.

In this specification, forward-backward, left-right, and upward-downward directions are referred to for convenience of explanation, and may be orthogonal directions with respect to each other. However, these directions are determined relative to a direction in which the seasoning provision device is disposed, and the upward-downward direction may not necessarily mean a vertical direction.

Food Material Transfer Unit 31 and Semi-Finished Product Transfer Unit 32

The seasoning provision device according to an embodiment of the present invention may include a food material preprocessing part 34. The food material preprocessing part 34 may be disposed at the rearmost side of the seasoning provision device so as to allow the food material to be placed thereon. Therefore, the food material preprocessing part 34 may be formed like a table. A worker or a moving device may preprocess the food material after placing the same on the food material preprocessing part 34. Preprocessing may include washing the food material or trimming the food material into a form suitable for producing the semi-finished product HG. The food material preprocessing part may include an input part through which an operator is able to check the state of the food material and input information related to the food material, such as the country of origin, the aspect ratio of the food material, and the number of leaves when the food material is a pickled cabbage. The input part may be electrically connected to the processor to be described later. The input part may include an input means such as a keyboard and a touch screen.

The seasoning provision device according to an embodiment of the present invention may include a food material transfer unit 31. The food material preprocessed in the food material preprocessing part 34 may be transferred to the food material transfer unit 31. The food material transfer unit 31 may mean a transfer part that transfers the food material to the work unit 10. The food material transfer unit 31 may extend from the front side of the food material preprocessing part 34 along the forward-backward direction, and transfer the food material received from the food material preprocessing part 34 forward.

The food material transferred through the food material transfer unit 31 may be placed on the work unit 10 by an operator or a moving device. Therefore, the food material transfer unit 31 may have an overlapping portion with the work unit 10 along the left-right direction. As shown, the food material transfer unit 31 may be disposed at a position spaced downward from the work unit 10. Therefore, the food material transferred by the food material transfer unit 31 may pass under the work unit 10.

The food material transfer unit 31 may include a food material conveyor that transfers the food material seated on a belt by rotating the belt by using a roller, and there may be a plurality of food material conveyors. The plurality of food material conveyors may be spaced apart from each other along the left-right direction.

The seasoning provision device according to an embodiment of the present invention may include a semi-finished product transfer unit 32. The semi-finished product transfer unit 32 may mean a transfer part that transfers the semi-finished product HG separated from the work unit 10. The semi-finished product transfer unit 32 may extend in the forward-backward direction to receive the semi-finished product HG discharged from the work unit 10 and transfer the same forward. Accordingly, the semi-finished product transfer unit 32 may have an overlapping portion with the work unit 10 along the left-right direction.

The semi-finished product transfer unit 32 may include a semi-finished product conveyor that transfers the food material seated on a belt by rotating the belt by using a roller, and there may be a plurality of semi-finished product conveyors. The plurality of semi-finished product conveyors may be disposed spaced apart from each other along the left-right direction. The semi-finished product conveyors may be disposed between the plurality of food material conveyors with reference to the left-right direction.

A speed at which the semi-finished product transfer unit 32 transfers the semi-finished product HG may be faster than a speed at which the food material transfer unit 31 transfers the food material. After the semi-finished product HG is seated on a semi-finished product conveyors, an operation thereof is continuously controlled by other conveyors, and thus there are not many delay factors. However, since the food material transfer unit 31 is affected by a work speed in the work unit 10, it may be desirable to speed up the transfer of an object on which the semi-finished product transfer unit 32 is seated rather than the food material transfer unit 31.

Work Unit 10

In the work unit (10), an application work by an operator is performed. If the food material is a pickled cabbage and the seasoning is kimchi, the application work may be a kimchi filling work. The work unit 10 may be provided to allow the food material to be seated such that the application work is easily performed, and may be provided to allow the food material to be positioned at a height that is higher than half the average height of a worker but smaller than the average height to allow the work by the worker to be easily performed.

The work unit 10 may include a plurality of work units 100a and 100b. The seasoning provision device according to an embodiment of the present invention may include a device frame 33. The above-described semi-finished product transfer unit 32, food material transfer unit 31, and work unit 10 may be coupled to the device frame 33, and the work units 100a and 100b may be spaced at predetermined intervals along the forward-backward direction. These work units 100a and 100b may be disposed at the left and right ends of the device frame 33 to allow a worker to easily access the same from the left and right sides. Each of the work units 100a and 100b is independently controlled by the processor, and may individually perform metering, which will be described later.

The work unit 10 may be provided to acquire the weight of the food material or semi-finished product HG to be seated. The work units 100a and 100b may include a worktable 11, a work elevating member 13, and a weight acquisition member 12. The worktable 11 is a part provided to allow the food material or semi-finished product HG to be seated, and may be formed in a plate shape. The work elevating member 13 is provided to elevate the worktable 11. The work elevating member 13 may have the same configuration as a hydraulic cylinder to achieve elevation through a linear motion, but an elevating means is not limited thereto.

The work elevating member 13 may lower the worktable 11 to make the worktable 11 to be seated on the weight acquisition member 12, or may elevate the worktable 11 to be separated upward from the weight acquisition member 12. When the worktable (11) is seated on the weight acquisition member (12), weight acquisition by the weight acquisition member (12) is possible. In a state in which the worktable 11 is separated upward from the weight acquisition member 12, weight acquisition may not be performed.

The weight acquisition member 12 is provided to acquire the weight of the food material or semi-finished product HG in a state in which the worktable 11 lowered by the work elevating member 13 is seated. Since the worktable (11) and the food material or semi-finished product HG thereon are seated together on the weight acquisition member (12), the weight of the food material or semi-finished product HG may be acquired by subtracting the weight of the worktable 11 from the weight acquired by the weight acquisition member 12. The weight acquisition member 12 may include a load cell for acquiring a weight. From information acquired from the load cell, the processor may calculate the weight of the food material or semi-finished product HG.

Seasoning Provision Unit 20

The seasoning provision unit 20 is provided to provide seasoning to the food material seated on the work unit 10. The seasoning provision unit 20 may provide, to the semi-finished product HG, seasoning as much as a seasoning provision amount, which is a predetermined weight. As will be described later, the seasoning provision amount may be determined on the basis of the weight of the food material. Seasoning is provided to the semi-finished product HG by the seasoning provision unit 20, and a worker may produce the semi-finished product HG by performing an application work. The seasoning provision unit 20 may include a seasoning storage tank and a seasoning distribution pipe 25. A large amount of seasoning may be stored in the seasoning storage tank. The seasoning stored in the seasoning storage tank may be provided to each of the seasoning provision units 200a and 200b through the seasoning distribution pipe 25 to allow a separate work to be performed at each position.

The seasoning provision unit 20 may include a plurality of seasoning provision units 200a and 200b. Each of the seasoning provision units 200a and 200b may be disposed at and coupled to a position corresponding to a position of each of the work units 100a and 100b on the device frame 33. Accordingly, the seasoning provision units 200a and 200b may be disposed at predetermined intervals along the forward-backward direction, and may be disposed at the left and right ends of the device frame 33. Each of the seasoning provision units 200a and 200b may be independently controlled by the processor to individually provide seasoning to the food material.

The seasoning provision units 200a and 200b may include a hopper 21. The hopper 21 may be formed in a funnel-like shape with a cross-sectional area decreasing downward to collect and discharge seasoning downward. An outlet of the seasoning distribution pipe 25 may be positioned at the upper side of each hopper 21 to allow seasoning discharged through the seasoning distribution pipe 25 to be transferred to the hopper 21. Seasoning may be temporarily stored in the hopper 21 and then discharged to the worktable 11 by a pump 22.

The seasoning provision units 200a and 200b may include the pump 22. The pump 22 may extrude seasoning that has fallen from the hopper 21 by the own weight thereof. The pump 22 may have two extruders that rotate in engagement with each other. The extruders may have a plurality of vanes, such as gears or gearwheels, and rotate in the same direction in the axial direction, and may be spaced apart from each other to rotate in engagement with each other.

The pump 22 may operate by receiving power. The pump 22 may be electrically connected to and controlled by the processor. The pump 22 may receive power from the processor, or may receive power from a separate power source. The processor may control the pump 22 to allow the pump 22 to extrude seasoning as much as the above-described seasoning provision amount. In order to extrude seasoning as much as a predetermined amount, a storage medium may include a mapping table corresponding to the amount of rotation of the extruders and the discharge amount of the seasoning. Accordingly, when the seasoning provision amount is determined by the processor, the processor may control the pump 22 such that the extruders rotates at a rotation amount corresponding to the seasoning provision amount.

The seasoning provision units 200a and 200b may include a seasoning cylinder 23. The seasoning cylinder 23 may push seasoning pushed by the two extruders of the pump 22 to the food material seated on the work unit 10. The seasoning may be pushed to the outside of the device frame 33 in the left-right direction by the pump 22, but due to the viscosity of the seasoning, the seasoning may not fall smoothly onto the food material with only the own weight thereof. The seasoning cylinder 23 may push the pushed seasoning downward to be smoothly discharged. Therefore, the seasoning cylinder 23 may be formed as a hydraulic cylinder capable of a linear motion along the vertical direction, but any other means capable of pushing the seasoning may be used.

The seasoning provision units 200a and 200b may include a seasoning valve 24. The seasoning valve 24 is a part that determines whether seasoning is discharged for the work unit 10, and may be located at the most end of a path through which seasoning flows in the seasoning provision units 200a and 200b. The seasoning valve 24 may be a cut-off valve. Therefore, the seasoning valve 24 may determine whether only seasoning is discharged. However, the seasoning valve 24 may be composed of a valve capable of adjusting an opening degree to finally determine a discharge amount of seasoning. The seasoning valve 24 may have a downwardly open shape. The seasoning valve 24 may be disposed at a position spaced upward from the worktable 11.

The seasoning provision units 200a and 200b may include seasoning switches operable by a worker. By using the seasoning switches, a worker may indicate whether the provision of seasoning may begin or whether an application work is complete. For the convenience of a worker performing an application work by hand, the seasoning switches may be disposed in a foot-controllable position.

The seasoning provision units 200a and 200b may include a supplement switch operable by a worker. By using the supplement switch, a worker may indicate whether provision of more seasoning is needed.

The seasoning may be transferred from the seasoning storage tank to the hopper 21 of each of the seasoning provision units 200a and 200b through the seasoning distribution pipe 25, transferred from the hopper 21 to the pump 22 to be extruded, and then pushed and discharged by the seasoning cylinder 23 to be discharged to the work unit 10 through the seasoning valve 24.

Display Part 80

The display part 80 is a part that displays necessary information to a worker. The display part 80 may be composed of a device capable of displaying visual information such as LED or LCD, but the type is not limited thereto. The display part 80 may be electrically connected to the processor and receive information to be displayed from the processor in the form of an electrical signal. The display part 80 may include an application rate display member 81 for displaying an application rate to be described later. The display part 80 may include a number display member 82 capable of displaying the number of times seasoning is discharged by the seasoning provision amount per unit or the remaining number of times. The application rate may be displayed on an illustrated application rate display part, and the number of times seasoning is discharged may be displayed on a discharge number display part.

The display part 80 may be disposed in a position that is easy for a worker to check. The display part 80 may be disposed above the worktable 11 and below the seasoning provision units 200a and 200b, and may be disposed to look outward with reference to the left-right direction.

Weight Acquisition Transfer Part 40

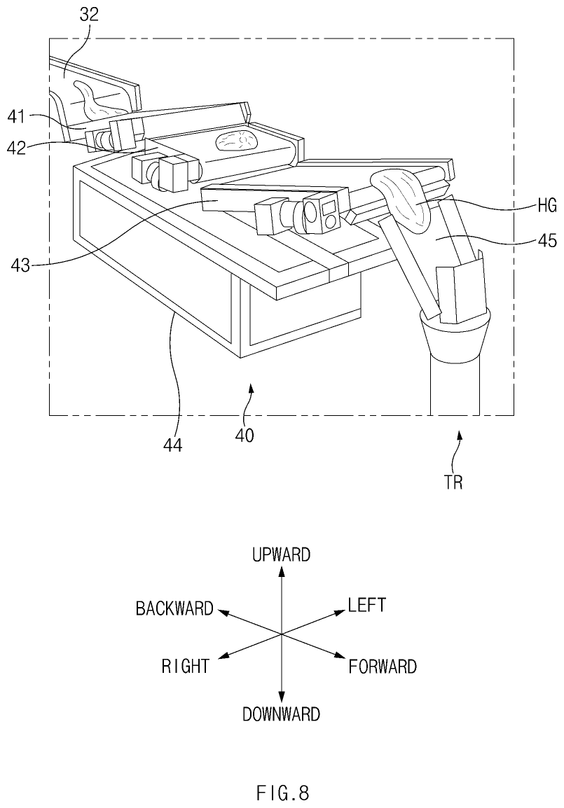

FIG. 8 is a perspective view of a weight acquisition transfer part 40 according to an embodiment of the present invention.

The seasoning provision device according to an embodiment of the present invention may include a weight acquisition transfer part 40. The semi-finished product HG transferred forward through the semi-finished product transfer unit 32 may be transferred to the weight acquisition transfer part 40. The weight acquisition transfer part 40 is provided to acquire the weight of the semi-finished product HG discharged from the work unit 10 and is provided to transfer the semi-finished product HG to a tray TR. The weight acquisition transfer part 40 may transfer the semi-finished product HG forward. Accordingly, the weight acquisition transfer part 40 may have a shape extending forward from a front end of the semi-finished product transfer unit 32. The weight acquisition transfer part 40 may be electrically connected to and controlled by the processor.

The weight acquisition transfer part 40 may include a double speed conveyor 41. The double speed conveyor 41, as a conveyor provided to transfer the semi-finished product HG discharged from the work unit 10, may transfer the semi-finished product HG at a high speed. The double speed conveyor 41 may transfer the semi-finished product HG at a higher speed than the speed of the semi-finished product transfer unit 32. Therefore, semi-finished products HG positioned close to each other and transferred when transferred by the semi-finished product transfer unit 32, may also be spaced apart from each other at a predetermined interval when reaching the double speed conveyor 41. The double speed conveyor 41 may have a longer length than the length of the weight conveyor 42 or a buffer conveyor 43, which will be described later, with reference to the forward-backward direction. The double speed conveyor 41 may be disposed to be inclined upward with respect to the front, which is the transferring direction of the semi-finished product HG.

The weight acquisition transfer part 40 may include a weight conveyor 42. The weight conveyor 42 is provided to acquire the weight of the semi-finished product HG while transferring the semi-finished product HG transferred from the double speed conveyor 41 to the tray TR. That is, the weight conveyor 42 may transfer the semi-finished product HG forward and acquire the weight of the semi-finished product HG. The weight acquired by the weight conveyor 42 may be transmitted to the processor in the form of an electrical signal. The weight conveyor 42 may be disposed horizontally.

The weight acquisition transfer part 40 may include a buffer conveyor 43. The buffer conveyor 43 is a conveyor that discharges the semi-finished product HG transferred from the weight conveyor 42 to the tray TR. Therefore, the double speed conveyor 41, the weight conveyor 42, and the buffer conveyor 43 may be disposed in order from the rear to the front. The buffer conveyor 43 may be disposed to be inclined upward with respect to the front.

The buffer conveyor 43 may transfer the semi-finished product HG forward and discharge the same to the tray TR under the control of the processor, or may stop to stop the semi-finished product HG. The processor may control the buffer conveyor 43 such that the total weight of the semi-finished product HG which one tray TR is able to contain is located within a predetermined range. The tray TR means a container capable of containing a semi-finished product HG, and as shown, may have a shape in which a funnel-shaped inlet is formed at an upper end of a cylindrical barrel with an open upper surface. A bottom plate of the tray TR is selectively opened, and the semi-finished product HG therein may be discharged downward.

The semi-finished product HG may fall from a front end of the buffer conveyor 43 and enter the tray TR. To allow the semi-finished product HG to safely enter the tray TR, the weight acquisition transfer part 40 may further include a semi-finished product guide 45. The semi-finished product guide 45 may be formed to have an inclined surface inclined downward with respect to the front of the buffer conveyor 43 toward the tray TR.

The double speed conveyor 41, the weight conveyor 42, and the buffer conveyor 43 may be coupled to the weight acquisition frame 44. The weight acquisition frame 44 may include a scrap box capable of collecting seasoning that may fall from each conveyor.

Tray Position Determination Part 50

The seasoning provision device according to an embodiment of the present invention may include a tray position determination part 50. The tray position determination part 50 is provided to determine positions of a plurality of trays TR. A tray TR may be transferred to an appropriate position or stopped by the tray position determination part 50. That is, the tray position determination part 50 may position the tray TR in a position 52 for receiving the semi-finished product HG from the weight acquisition transfer part 40, a position 54 for transferring the tray TR to a tray lifter 70, a position 53 for transferring the tray TR to a supplement part 60, or the like.

The tray position determination part 50 may include a tray conveyor 51 to allow the tray TR to be seated and transferred thereon. The tray conveyor 51 may draw a closed circuit to allow the tray TR to circulate.

The tray TR may be disposed in front of the weight acquisition transfer part 40 by the tray position determination part 50. In this position, the tray TR may receive the semi-finished product HG from the weight acquisition transfer part 40. When the total amount of the weight of the semi-finished product HG contained in one tray TR is within a predetermined weight range and the tray TR receives a semi-finished product HG in a next order, the tray TR is no longer able to receive a semi-finished product HG if the tray TR is out of the above-described weight range. Thus, the tray position determination part 50 transfers the corresponding tray TR to the supplement part 60. The weight of semi-finished products HG contained in the tray TR is corrected in the supplement part 60, and then the tray TR is transferred to the tray lifter 70 by the tray position determination part 50. The seasoning provision device according to an embodiment of the present invention may include the tray lifter 70. The tray lifter 70 may elevates the tray TR upward and open a bottom plate of the tray TR to allow the semi-finished products HG to enter a lower packaging material positioned under the tray TR. Thereafter, the empty tray TR may be lowered again by the tray lifter 70, and the tray position determination part 50 may send the empty tray TR to the front of the weight acquisition transfer part 40 again to repeat the same process. The semi-finished product HG in the packaging material can be transferred to a packaging device.

The seasoning provision device according to an embodiment of the present invention may include the supplement part 60. When the weight of the semi-finished product HG contained in the tray TR is too large or too small, the supplement part 60 supplements this. In the supplement part 60, a supplement work by a worker may be performed. The supplement part 60 may include a supplement worktable provided with a supplement opening opened in the upward-downward direction to expose an upper surface of the tray TR upward, such that it is possible to allow a supplement work for at least one semi-finished product HG contained in the tray TR to be performed. A worker is able to perform the supplement work by accessing the inside of the tray TR through the supplement opening of the supplementary worktable. The supplement work may be performed by removing a part of the semi-finished product HG or adding a piece of the semi-finished product HG prepared in advance to the tray TR. If the semi-finished product HG is a kimchi semi-finished product HG, then in the supplement work, seasoning may be supplemented, a sheet of kimchi leaf may be supplemented, or a sheet of kimchi leaf may be removed. In the supplement part 60, a means such as a supplement load cell for measuring the weight of the semi-finished product HG contained in the tray TR may be disposed, and a supplement display part 80 electrically connected to the supplement load cell may be disposed to allow the total weight of the semi-finished product HG contained in the working tray TR to be displayed in real time.

Auxiliary Seasoning Provision Unit (not Shown)

A seasoning provision device according to an embodiment of the present invention may include an auxiliary seasoning provision unit. However, the auxiliary seasoning provision unit is not shown in the drawings. An auxiliary seasoning provision unit is provided to provide and apply more seasoning to the semi-finished product HG. The semi-finished product HG may be primarily produced by the work unit 10, and the seasoning may be more evenly applied to the semi-finished product HG by the auxiliary seasoning provision unit.

The auxiliary seasoning provision unit may be disposed between the semi-finished product transfer unit 32 and the weight acquisition transfer part 40, may be disposed between the weight acquisition transfer part 40 and the tray position determination part 50, or may be disposed between the semi-finished product transfer unit 32 and the work unit 10.

The auxiliary seasoning provision unit may include a drum-type stirrer that is hollow and rotatable to allow the seasoning and semi-finished product HG contained therein to be rotated or dropped and stirred together. Alternatively, the stirrer may include a spiral Archimedean rotating plate rotating inside a barrel to stir the seasoning and the semi-finished product HG. To provide vacuum to the stirrer, the auxiliary seasoning provision unit may include an auxiliary seasoning blower. The auxiliary seasoning provision unit may include a vibration motor to allow the stirrer to vibrate the semi-finished product HG. However, a means which the auxiliary seasoning provision unit includes to further apply seasoning to the semi-finished product HG is not limited thereto.

Processor

The processor is provided to control the seasoning provision device. The processor may be electrically connected to the work unit 10 and the seasoning provision unit 20, but may also be electrically connected to other components of the seasoning provision device. The processor, as a component including an element capable of performing logic computation for performing control commands, may include a central processing unit (CPU) and the like. The processor may be connected to various components, may transmit a signal according to a control command to each component to perform control, and may be connected to various sensors or acquisition parts to receive acquired information in the form of a signal. Since the processor may be electrically connected to each of the components, mutual communication is possible by further including a communication module communicable wirelessly or having wired connection.

The seasoning provision device according to an embodiment of the present invention may further include a storage medium to allow control commands executed by the processor to be stored and utilized in the storage medium. The storage medium may be a device such as a hard disk drive (HDD), a solid state drive (SSD), a server, a volatile medium, or a non-volatile medium, but the type is not limited thereto. In addition, data or the like required for the processor to perform a work may be further stored in the storage medium.

The seasoning provision device according to an embodiment of the present invention may further include an operation part. The operation part may include mechanical structures such as control switches and buttons operable by a user, and a display device capable of displaying a state of the seasoning provision device, and may be electrically connected to the processor.

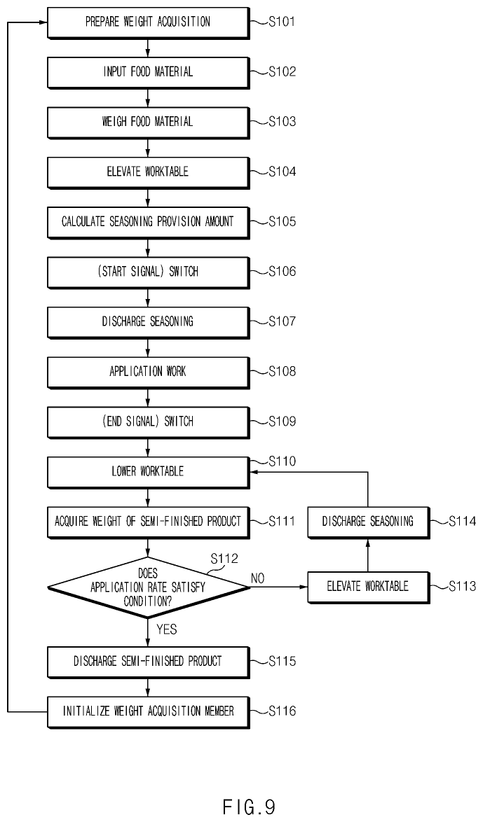

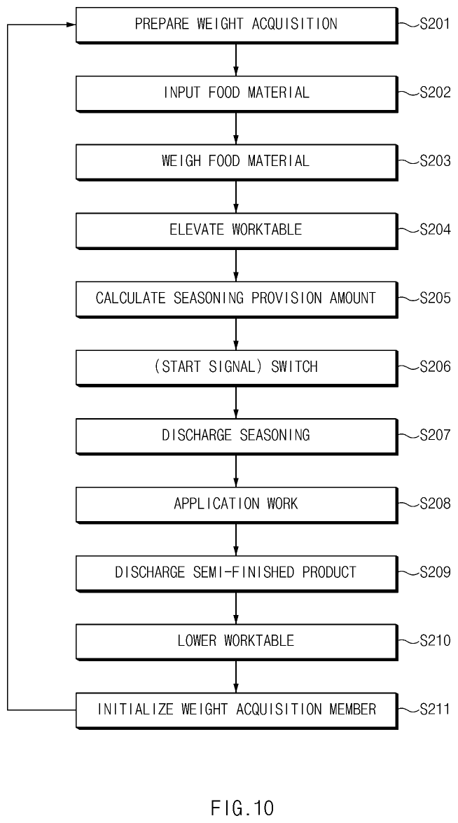

FIG. 9 is a flow chart of a seasoning provision method according to an embodiment of the present invention. FIG. 10 is a flowchart of a seasoning provision method according to a modified example of an embodiment of the present invention.

Hereinafter, a seasoning providing method and processor control will be described using FIGS. 9 and 10. What is described as being performed by a worker below may be equally performed by a moving device or a gripping device that performs a corresponding function.

A food material may be prepared. The food material may be preprocessed in the food material preprocessing part 34, and the preprocessed food material may be seated on the food material transfer unit 31 and transferred forward. The food material transferred forward may be placed on the worktable (11) by a worker. Before the food material is placed on the worktable 11 by the worker, the acquisition of the weight of the food material may be prepared (S101 and S201). The processor may control the work elevating member 13 such that the worktable 11 is lowered by the work elevating member 13, and may control the weight acquisition member 12 such that the weight acquisition member 12 is initialized and zeroed in a state in which the worktable 11 is seated on the weight acquisition member 12.

Thereafter, the food material may be put into the work unit 10 (S102 and S202). The food material may be seated on the worktable 11. When the food material is seated on the worktable 11, the processor may control the weight acquisition member 12 to acquire the weight of the food material. The processor may receive information related to the food material from the input part, and the weighing of the food material (S103 and S203) may include acquiring the weight of the food material and receiving information related to the food material. After the weight is acquired, the processor may control the work elevating member 13 to elevate the worktable 11 (S104 and S204). The processor may receive the acquired weight from the work unit 10 and determine a seasoning provision amount on the basis of the acquired weight of the food material (S105 and S205).

The processor may control the seasoning provision unit 20 such that a semi-finished product HG is produced by providing seasoning according to the determined seasoning provision amount. The processor may calculate the seasoning provision amount such that a value acquired by dividing the seasoning provision amount by the sum of the food material and the seasoning provision amount satisfies a predetermined application rate. The above-described application rate may satisfy a condition of equal to or greater than a first reference value and equal to or less than a second reference value. The second reference value is greater than or equal to the first reference value. When the seasoning provision amount is calculated, the processor may find a rotation amount of the pump 22 corresponding to the seasoning provision amount in the mapping table.

When seasoning is ready to be applied to the food material, a worker may operate the seasoning switches (S105 and S205). The worker may give a start signal by operating the seasoning switches. When the seasoning switches are operated, the processor may receive a signal and control the seasoning provision unit 20 to start discharging the seasoning (S107 and S207). The processor may control the seasoning provision unit 20 to provide seasoning as much as the seasoning provision amount determined by the weight of the food material currently seated on the worktable 11. The processor may control the pump 22 to rotate the extruders of the pump 22 as much as a rotation amount corresponding to the seasoning provision amount.

The processor may control the seasoning provision unit 20 to provide seasoning to the food material a predetermined number of times by unit seasoning provision amount such that the total amount of the seasoning provided to the food material is within a predetermined range from the seasoning provision amount. That is, the seasoning provision unit 20 does not discharge the seasoning as much as the seasoning provision amount to the food material at once, but discharges the seasoning as much as the unit seasoning provision amount, which is smaller than the seasoning provision amount, several times to the food material, such that it is possible to provide seasoning as much as an amount positioned within a predetermined range from the seasoning provision amount. The processor may transmit, to the display part 80, the number of times the seasoning has been discharged by the unit seasoning provision amount or the number of times remaining among the total number of times to be discharged, and may control the display part 80 to display the number. However, the processor may also control the seasoning provision unit 20 to continuously provide seasoning as much as the seasoning provision amount.

Since seasoning is discharged to the worktable (11), a worker is able to produce a semi-finished product HG by performing an application work on the food material by using the discharged seasoning (S108 and S208). Up to this point, the seasoning provision method according to an embodiment of the present invention and the seasoning provision method according to a modified example of an embodiment may be performed identically.

Thereafter, in the seasoning provision method according to a modified example of an embodiment of the present invention, discharging the semi-finished product HG from the worktable 11 to the semi-finished product transfer unit 32 by a worker (S209), controlling the work elevating member 13 to lower the worktable 11 by the processor (S210), and controlling the weight acquisition member 12 by the processor to initialize the weight acquisition member 12 (S211) may be performed, and all steps may be repeated after returning to preparing primary weight acquisition (S201). Therefore, according to a modified example of an embodiment of the present invention, it is possible to weigh the food material fast and provide an appropriate amount of seasoning to the food material, thereby improving productivity while producing a semi-finished product HG of uniform quality.

According to the seasoning provision method according to an embodiment of the present invention, after the application work (S108) is finished, a user may operate the seasoning switches (S109). A worker may operate the seasoning switches to signal that the application work is complete. When the seasoning switches are operated, the processor may receive a signal and control the work elevating member 13 to lower the worktable 11 (S110), and it is possible to control the weight acquisition member 12 to acquire the weight of the semi-finished product HG seated on the worktable 11 (S111). The processor may receive the acquired weight of the semi-finished product HG.

The processor may calculate an application rate in a current state on the basis of the acquired weight of the semi-finished product HG. The application rate in the current state is a value acquired by dividing, by the sum of the acquired weight of the semi-finished product HG, a value acquired by subtracting the acquired weight of the food material from the acquired weight of the semi-finished product HG. When the application rate is calculated, the processor may transfer the value thereof to the display part 80 in the form of an electrical signal to be displayed. A worker may check the displayed application rate.

The processor may check whether the calculated application rate satisfies a predetermined condition (S112). The predetermined condition may be that the application rate should be greater than or equal to a predetermined lower limit application rate.

If the application rate is lower than the lower limit application rate, the processor may determine that seasoning supplementation is necessary or a worker may operate the supplement switch after determining that seasoning supplementation is necessary. The lower limit application rate may be equal to the first reference value. The amount of seasoning that satisfies the lower limit application rate may be referred to as a seasoning lower limit amount. That is, a state in which seasoning needs to be supplemented is that the seasoning was provided in an amount less than the seasoning lower limit amount.

When it is determined that seasoning supplementation is necessary, the processor may control the work elevating member 13 to elevate the worktable 11 (S113) and may control the seasoning provision unit 20 to discharge a predetermined amount of supplemental seasoning (S114). When more seasoning is discharged, a worker may perform an application work of applying more seasoning to the semi-finished product HG, and then the processor may control the work elevating member 13 to lower the worktable 11 again and may control the weight acquisition member 12 to acquire the weight of the semi-finished product HG again. The processor may calculate an application rate again from the weight acquired again. If the application rate calculated again does not exceed the lower limit application rate, the above-described supplement process may be repeated. If the application rate calculated again is greater than or equal to the lower limit application rate, a procedure may proceed to a next step.

If the application rate calculated again is higher than the lower limit application rate, the semi-finished product HG may be discharged, and thus a worker may transfer the semi-finished product HG to the semi-finished product transfer unit 32 (S115). When the semi-finished product HG is separated from the worktable 11 and is transferred to the semi-finished product transfer unit 32, the processor may initialize the weight acquisition member 12 (S116). Thereafter, the processor may return to preparing primary weight acquisition (S101) and repeat all steps.

According to an embodiment of the present invention, it is possible to supplement seasoning so as to satisfy an appropriate application rate, and thus it is possible to produce a semi-finished product HG of uniform quality.

The processor may control the buffer conveyor 43 of the tray position determination part 50 and the weight acquisition transfer part 40, such that the total weight of the semi-finished product HG provided in one tray TR is within a predetermined range. The processor may control the buffer conveyor 43 to operate or stop, thereby allowing the semi-finished product HG, whose weight has been acquired from the previous weight conveyor 42, to be put into a specific tray TR or not to be put thereinto.

The processor may form a database of production information acquired in a process of providing seasoning and store the same in a storage medium. When providing seasoning, the processor may store at least one of the food material, the seasoning provision amount, the weight of the semi-finished product HG, an application rate acquired by dividing the seasoning provision amount by the weight of the semi-finished product HG, a time including at least one of the year, month, day, and time of providing the seasoning, the type of the food material, the type of the seasoning, the number of leaves if the food material is a pickled cabbage, an aspect ratio of the food material, a worker's information, a manager's information, and the origin of the food material, after making the at least one into a database.

A seasoning provision system according to an embodiment of the present invention may include the above-described seasoning provision device and a seasoning provision management device. The seasoning provision device and the seasoning provision management device may be electrically connected or communicably connected to each other.

The seasoning provision device and the seasoning provision management device may each include a communication module to be communicable with each other. The communication module may be implemented with various communication technologies. WIFI, Wideband CDMA (WCDMA), High Speed Downlink Packet Access (HSDPA), High Speed Uplink Packet Access (HSUPA), High Speed Packet Access (HSPA), Mobile WiMAX, WiBro, Long Term Evolution (LTE), Bluetooth, infrared data association (IrDA), Near Field Communication (NFC), Zigbee, wireless LAN technology, etc. may be applied to the communication module. In addition, when providing services in connection with the Internet, TCP/IP, which is a standard protocol for information transmission on the Internet, may be followed.

The seasoning provision management device may include the above-described communication module and an information processing unit. The seasoning provision management device may be a server capable of communication and computation. However, a device capable of implementing the seasoning provision management device is not limited thereto.

The communication module of the seasoning provision management device may include a receiving unit and a transmitting unit. The receiving unit is provided to receive information including at least one of various pieces of production information such as season information, the origin of the food material, the size of the food material, and the weight of the food material from the seasoning provision device.

The information processing unit generates processing information on the basis of the received production information. The processing information may include various values and pieces of information which may be generated using the production information, such as a value calculated by weighting values included in the production information.

The seasoning provision management device may include a storage part. The received production information and processing information generated from the information processing unit may be made into a database similarly to the above-described database and stored in the storage part.

The seasoning provision management device may include an operation mode determination part. The operation mode determination part may determine an operation mode of the seasoning provision device on the basis of the processing information. The operation mode determination part may determine an operation mode of the seasoning provision device further on the basis of the production information. The seasoning provision management device may determine an operation mode by using the accumulated production information and processing information made into a database. An operation mode of the seasoning provision device indicates to which numerical values various control amounts, including an application rate, a unit seasoning provision amount, a supplement seasoning provision amount, and the like, are to be set. Therefore, as an operation mode changes, the above-described control amounts may change. To determine an operation mode, the operation mode determination part may have an operation mode determination algorithm, and may learn the operation mode determination algorithm by using the above-described processing information and production information.

The communication module of the seasoning provision management device may include a transmitting unit capable of transmitting a control signal to the seasoning provision device. The transmitting unit may transmit a control signal related to an operation mode of the seasoning provision device determined on the basis of the processing information generated from the information processing unit to the seasoning provision device. The seasoning provision device having received the control signal may be operated according to an operation mode indicated by the control signal.

In the above, even though all the components constituting the embodiments of the present invention have been described as being combined or operated as one, the present invention is not necessarily limited to these embodiments. That is, within the scope of the object of the present invention, all of the components may be selectively combined with one or more to operate. In addition, terms such as “include”, “comprise” or “have” described above mean that the corresponding component may be present unless otherwise stated, and thus should be construed as being able to further include other components, not as excluding other components. All terms, including technical or scientific terms, have the same meaning as commonly understood by a person of ordinary skill in the art to which the present invention belongs, unless defined otherwise. Commonly used terms, such as terms defined in a dictionary, should be interpreted as consistent with the contextual meaning of the related art, and unless explicitly defined in the present invention, they are not interpreted in an ideal or excessively formal meaning.

The above description is merely an example of the technical idea of the present invention, and various modifications and variations can be made to those skilled in the art without departing from the essential characteristics of the present invention. Therefore, the embodiments disclosed in the present invention are not intended to limit the technical idea of the present invention, but to explain, and the scope of the technical idea of the present invention is not limited by these embodiments. The protection scope of the present invention should be construed according to the claims below, and all technical ideas within the equivalent range should be construed as being included in the scope of the present invention.

1. A seasoning provision device comprising:
a work unit provided to acquire the weight of a food material to be seated thereon;
a seasoning provision unit provided to form a semi-finished product by providing seasoning of a seasoning provision amount, which is a predetermined weight, to the food material seated on the work unit; and
a processor electrically connected to the work unit and the seasoning provision unit,
wherein the processor controls the seasoning provision unit such that seasoning is provided according to the seasoning provision amount determined on the basis of the weight of the food material acquired by the work unit.

2. The seasoning provision device of claim 1, wherein the processor comprises a mapping table in which the weight of the food material and the seasoning provision amount are made to correspond to each other.

3. The seasoning provision device of claim 1, wherein the processor calculates an application rate acquired by dividing a value acquired by subtracting the weight of the food material from the weight of the semi-finished product by the sum of the weight of the semi-finished product, and
the seasoning provision device further comprises a display part electrically connected to the processor and provided to display the application rate.

4. The seasoning provision device of claim 1, wherein the processor calculates the seasoning provision amount such that a value acquired by dividing the seasoning provision amount by the sum of the amount of the food material and the seasoning provision amount is greater than or equal to a first reference value and less than or equal to a second reference value.

5. The seasoning provision device of claim 1, wherein the work unit comprises:
a worktable provided to allow the food material or the semi-finished product to be seated thereon;
a work elevating member provided to elevate the worktable; and
a weight acquisition member provided to acquire the weight of the food material or the semi-finished product in a state in which the worktable lowered by the work elevating member is seated.

6. The seasoning provision device of claim 5, wherein the processor controls the weight acquisition member such that the weight acquisition member is initialized, when the weight of the semi-finished product is acquired and then the semi-finished product is separated from the worktable.

7. The seasoning provision device of claim 5, wherein the weight acquisition member comprises a load cell for acquiring a weight.

8. The seasoning provision device of claim 1, wherein the processor controls the seasoning provision unit to provide seasoning to the food material a predetermined number of times by a unit seasoning provision amount such that the total amount of the seasoning provided to the food material is within a predetermined range from the seasoning provision amount.

9. The seasoning provision device of claim 1, wherein the seasoning provision unit comprises:
a pump for extruding the seasoning; and
a seasoning cylinder for discharging seasoning pushed by the pump to the food material seated on the work unit.

10. The seasoning provision device of claim 1, wherein the seasoning provision unit includes a plurality of seasoning provision units that are independently controlled by the processor to individually provide seasoning.

11. The seasoning provision device of claim 1, further comprising:
a food material transfer unit for transferring the food material to the work unit; and
a semi-finished product transfer unit for transferring the semi-finished product separated from the work unit,
wherein a speed at which the semi-finished product transfer unit transfers the semi-finished product is faster than a speed at which the food material transfer unit transfers the food material.

12. The seasoning provision device of claim 1, further comprising a weight acquisition transfer part provided to acquire the weight of the semi-finished product discharged from the work unit and to transfer the semi-finished product to a tray.

13. The seasoning provision device of claim 12, wherein:
the weight acquisition transfer part is electrically connected to the processor;
the seasoning provision device further comprises a tray position determination part for determining positions of a plurality of trays; and
the processor controls the tray position determination part and the weight acquisition transfer part such that the total weight of the semi-finished product provided to one of the trays is within a predetermined range.

14. The seasoning provision device of claim 12, further comprising a semi-finished product transfer unit for transferring the semi-finished product separated from the work unit,
wherein the weight acquisition transfer part comprises a double speed conveyor provided to transfer the semi-finished product discharged from the work unit, and a weight conveyor provided to acquire the weight of the semi-finished product transferred from the double speed conveyor, and
a speed at which the double speed conveyor transfers the semi-finished product is faster than a speed at which the semi-finished product transfer unit transfers the semi-finished product.

15. The seasoning provision device of claim 12, further comprising:
a tray position determination part provided to determine a position of a tray for containing at least one semi-finished product transferred by the weight acquisition transfer part; and
a supplement part having a supplement load cell provided to acquire the weight of at least one semi-finished product contained in the tray transferred by the tray position determination part, and a supplement worktable for exposing an upper surface of the tray upward such that supplement work for the semi-finished product can be performed.

16. The seasoning provision device of claim 1, further comprising an auxiliary seasoning provision unit which, in order to further provide the seasoning to the semi-finished product, performs at least one of vibrating the semi-finished product, rotating the semi-finished product, dropping the semi-finished product, and providing vacuum.

17. The seasoning provision device of claim 1, wherein, when providing the seasoning to the food material, the processor stores at least one of the weight of the food material, the seasoning provision amount, the weight of the semi-finished product, an application rate acquired by dividing the seasoning provision amount by the weight of the semi-finished product, and a time of providing the seasoning, after making the at least one into a database.

18. A seasoning provision method comprising:
preparing a food material;
acquiring the weight of the food material; and
producing a semi-finished product by providing seasoning to the food material according to a seasoning provision amount determined on the basis of the acquired weight of the food material.

19. The seasoning provision method of claim 18, further comprising acquiring the weight of the semi-finished product after the semi-finished product is produced.

20. The seasoning provision method of claim 19, further comprising:
on the basis of the acquired weight of the semi-finished product, checking whether the seasoning has been provided as much as a seasoning lower limit amount that is a predetermined amount smaller than the seasoning provision amount; and
when the seasoning has been provided in an amount less than the seasoning lower limit amount, providing the seasoning more as much as a predetermined supplement seasoning amount.

21. (canceled)
